(19) United States
(12) Patent Application Publication
(10) Pub. No.: US 2026/0106661 A1
(43) Pub. Date: Apr. 16, 2026

(54) USER EQUIPMENT INDICATION OF PREFERENCE FOR DOWNLINK OR UPLINK BEAM TRAINING

(71) Applicant: QUALCOMM Incorporated, San Diego, CA (US)

(72) Inventors: Vasanthan RAGHAVAN, West Windsor Township, NJ (US); Junyi LI, Greentown, PA (US); Jung Ho RYU, Fort Lee, NJ (US)

(21) Appl. No.: 18/915,946

(22) Filed: Oct. 15, 2024

(51) Int. Cl. H04B 7/06; H04W 28/08

(52) U.S. Cl. CPC H04B 7/0696; H04W 28/0858

(57) ABSTRACT

Various aspects of the present disclosure generally relate to wireless communication. In some aspects, a user equipment (UE) may detect one or more trigger conditions at the UE. The UE may transmit, to a network node, an indication of a preference associated with downlink beam training or uplink beam training, wherein the preference is based at least in part on the one or more trigger conditions at the UE. Numerous other aspects are described.

### FIELD OF THE DISCLOSURE

Aspects of the present disclosure generally relate to wireless communication and specifically relate to techniques, apparatuses, and methods associated with a user equipment (UE) indication of a preference for downlink or uplink beam training.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to cause the UE to detect one or more trigger conditions at the UE. The one or more processors may be configured to cause the UE to transmit, to a network node, an indication of a preference associated with downlink beam training or uplink beam training, wherein the preference is based at least in part on the one or more trigger conditions at the UE.

Some aspects described herein relate to a network node for wireless communication. The network node may include one or more memories and one or more processors coupled to the one or more memories. The one or more processors may be configured to cause the network node to receive, from a UE, an indication of a preference associated with downlink beam training or uplink beam training. The one or more processors may be configured to cause the network node to transmit, to the UE and based at least in part on the indication of the preference, a communication indicating downlink reference signals to be measured for downlink beam training or uplink reference signals to be transmitted for uplink beam training.

Some aspects described herein relate to a method of wireless communication performed by a UE. The method may include detecting one or more trigger conditions at the UE. The method may include transmitting, to a network node, an indication of a preference associated with downlink beam training or uplink beam training, wherein the preference is based at least in part on the one or more trigger conditions at the UE.

Some aspects described herein relate to a method of wireless communication performed by a network node. The method may include receiving, from a UE, an indication of a preference associated with downlink beam training or uplink beam training. The method may include transmitting, to the UE and based at least in part on the indication of the preference, a communication indicating downlink reference signals to be measured for downlink beam training or uplink reference signals to be transmitted for uplink beam training.

Some aspects described herein relate to a non-transitory computer-readable medium that stores a set of instructions for wireless communication by a UE. The set of instructions, when executed by one or more processors of the UE, may cause the UE to detect one or more trigger conditions at the UE. The set of instructions, when executed by one or more processors of the UE, may cause the UE to transmit, to a network node, an indication of a preference associated with downlink beam training or uplink beam training, wherein the preference is based at least in part on the one or more trigger conditions at the UE.

Some aspects described herein relate to a non-transitory computer-readable medium that stores a set of instructions for wireless communication by a network node. The set of instructions, when executed by one or more processors of the network node, may cause the network node to receive, from a UE, an indication of a preference associated with downlink beam training or uplink beam training. The set of instructions, when executed by one or more processors of the network node, may cause the network node to transmit, to the UE and based at least in part on the indication of the preference, a communication indicating downlink reference signals to be measured for downlink beam training or uplink reference signals to be transmitted for uplink beam training.

Some aspects described herein relate to an apparatus for wireless communication. The apparatus may include means for detecting one or more trigger conditions. The apparatus may include means for transmitting, to a network node, an indication of a preference associated with downlink beam training or uplink beam training, wherein the preference is based at least in part on the one or more trigger conditions.

Some aspects described herein relate to an apparatus for wireless communication. The apparatus may include means for receiving, from a UE, an indication of a preference associated with downlink beam training or uplink beam training. The apparatus may include means for transmitting, to the UE and based at least in part on the indication of the preference, a communication indicating downlink reference signals to be measured for downlink beam training or uplink reference signals to be transmitted for uplink beam training.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of channel state information reference signal (CSI-RS) beam management procedures, in accordance with the present disclosure.

FIGS. 4A-4B are diagrams illustrating examples associated with a user equipment (UE) indication of a preference for downlink or uplink beam training, in accordance with the present disclosure.

FIG. 5 is a diagram illustrating an example process performed, for example, at a UE or an apparatus of a UE, in accordance with the present disclosure.

FIG. 6 is a diagram illustrating an example process performed, for example, at a network node or an apparatus of a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node and a user equipment (UE) may use multi-antenna beamforming for communications in a wireless communication network. For example, multi-antenna beamforming is often used by wireless communication devices (e.g., network nodes and UEs) operating in an FR1 frequency band, as well as wireless communication devices operating in an FR2 or millimeter wave frequency band. In some examples, downlink beam training (also referred to as “downlink-based beam training” or “downlink beamforming training”) may be used for selection, management, and/or refinement of beams for communications between a UE and network node. Downlink beam training refers to beam training, beam management, and/or beam refinement based on downlink reference signals, such as synchronization signal blocks (SSBs) or channel state information (CSI) reference signals (CSI-RSs). For example, downlink beam training may include a P1 procedure for initial beam acquisition/selection, a P2 procedure for beam refinement at the network node side, and a P3 procedure for beam refinement at the UE side. The P1, P2, and P3 procedures may be used for establishing and/or refining single user (SU) or multi-user (MU) multiple-input multiple-output (MIMO) links. In some examples, downlink beam training (e.g., the P1, P2, and/or P3 procedures) may be performed using SSBs. In some other examples, downlink beam training may be performed using CSI-RSs. In downlink beam training procedures (e.g., the P1, P2, and P3 procedures), beams for the UE and the network node may be selected and/or refined based on measurements (e.g., reference signal received power (RSRP) measurements and/or signal-to-interference-plus-noise ratio (SINR) measurements) of downlink reference signals (e.g., SSBs or CSI-RSs) performed by the UE and reported to the network node.

In some examples, uplink beam training (also referred to as “uplink-based beamforming” or “uplink beamforming training”) may be used for selection, management, and/or refinement of beams for communications between a UE and network node. Uplink beam training refers to beam training, beam management, and/or beam refinement based on uplink reference signals, such as sounding reference signals (SRSs). For example, the UE may transmit one or more SRSs, and the network node may perform measurements of the SRSs. The network node may derive and/or refine the beams to be used by the UE and the network node for communications (e.g., downlink and/or uplink communications) between the UE and the network node based on the measurements of the SRSs.

There are various tradeoffs between using downlink beam training (e.g., CSI-RS-based beam training) or uplink beam training (e.g., SRS-based beam training) for beam management in a wireless communication network. Uplink beam training may have an advantage with asymmetrical/large antenna dimensions at network node, which results in uplink beam training having a reduced latency as compared with downlink beam training. Downlink beam training may lead to a large feedback signaling overhead associated with CSI reporting, and uplink beam training may result in reduced signaling overhead as compared with downlink beam training, by avoiding the feedback overhead associated with CSI reporting. However, CSI-RS resource allocation (for downlink beam training) may be more flexible than SRS resource allocation (for uplink beam training) in terms of density and/or location, among other examples. For example, an SRS may be allocated in 1, 2, or 4 consecutive symbols, but the SRS may be constrained to the last 6 symbols of a slot. A CSI-RS may be allocated in 1, 2, or 4, consecutive symbols, but the CSI-RS may begin anywhere within a slot. Additionally, a CSI-RS may be periodic, semi-persistent, or aperiodic. Further, SRSs are typically UE-specific, whereas CSI-RSs can be configured as shared resources across multiple UEs (although CSI-RS can also be UE-specific). Accordingly, the system level overhead (e.g., across all of the UEs in a cell) for uplink beam training (e.g., SRS-based beam training) may be larger than for downlink beam training (although, in a multiple transmit receive point (mTRP) scenario, the system level overhead may be larger for downlink beam training than for uplink beam training). Moreover, uplink beam training may be limited by link budget and/or operating conditions at the UE. For example, SRS transmission may be limited by a link budget (e.g., equivalent isotropic radiated power (EIRP) differences between the network node and the UE). In some examples, maximum permissible exposure (MPE) constraints and/or blockage conditions at the UE (e.g., one or more antennas of the UE blocked by an obstacle) may render SRSs transmitted by the UE ineffectual for uplink beam training. Additionally, or alternatively, power considerations at the UE (e.g., SRS transmission uses more power than CSI-RS reception) and/or thermal considerations at the UE may favor downlink beam training over uplink beam training.

Many of the tradeoffs between downlink beam training and uplink beam training are affected by dynamic conditions, in the network and at the UE, that may change over time. The choice for whether to use downlink beam training or uplink beam training is currently left to network node implementation. However, the network node has no information about the current operating conditions at the UE and/or a type of beam training preferred or recommended by the UE. In particular, a wireless communication standard promulgated by the Third Generation Partnership Project (3GPP) does not currently allow the UE to provide any preference or recommendation for the type of beam training to the network node. While link budget conditions can be inferred by path loss estimates made at the network node, conditions such as a blockage at the UE, battery power remaining at the UE, and/or MPE constraints of the UE, among other examples, which could significantly impact downlink versus uplink beam training decisions cannot be perfectly inferred at the network node. In this context, the network node cannot currently consider a recommendation or preference of a UE (or operating conditions at the UE) when selecting whether downlink beam training or uplink beam training is to be used for the UE. This may result in increased latency of the beam training and/or decreased reliability of the beams used to communicate between the UE and the network node due to selection of a type of beam training that is ineffectual, unreliable, or impossible (e.g., due to an MPE constraint or a blockage) for the UE under current operating conditions.

Various aspects relate generally to a UE recommendation or preference for downlink or uplink beam training. Some aspects more specifically relate to a dynamic UE recommendation or preference for downlink or uplink beam training based on operating conditions at the UE. In some aspects, the UE may detect one or more trigger conditions at the UE. For example, the one or more trigger conditions may be operating conditions at the UE, such as a temperature level or measured thermal overhead at the UE, EIRP associated with downlink transmissions from the network node and/or EIRP associated with uplink transmissions from the UE, a link budget, an MPE condition at the UE, a blockage condition at the UE, and/or a quantity of antenna modules or antenna panels available at the UE. The UE may transmit, to a network node, an indication of a preference associated with downlink beam training or uplink beam training, where the preference is based at least in part on the one or more trigger conditions. In some aspects, the network node may receive the indication of the preference associated with downlink beam training or uplink beam training, and the network node may transmit, to the UE and based at least in part on the indication of the preference, a communication indicating downlink reference signals to be measured for downlink beam training or uplink reference signals to be transmitted for uplink beam training. In some aspects, the indication of the preference may also include an indication of a preferred slot format indicator (SFI). In some aspects, the UE may transmit, to the network node (e.g., in addition to or instead of the indication of the preference), an indication to switch traffic associated with the UE to a companion or neighbor UE associated with the UE. For example, the companion or neighbor UE may be another UE associated with a same user as the UE. The indication to switch the traffic associated with the UE to the companion or neighbor UE may be based at least in part on the one or more trigger conditions at the UE. For example, the indication to switch the traffic associated with the UE to the companion or neighbor UE may be based at least in part on an MPE condition and/or a blockage condition at the UE.

Particular aspects of the subject matter described in this disclosure can be implemented to realize one or more of the following potential advantages. In some examples, by the UE transmitting the indication of the preference associated with downlink beam training or uplink beam training, where the preference is based at least in part on the trigger conditions at the UE, the described techniques can be used to enable dynamic selection, by the network node, of downlink beam training or uplink beam training informed by a dynamic preference of the UE that is based at least in part on the trigger conditions at the UE. In this way, latency of the beam training may be reduced and/or reliability of the beam training may be increased due to the network node being informed of a preference of the UE (and/or preferences of other UEs) when selecting between downlink beam training or uplink beam training.

In some examples, by the UE transmitting an indication of a preferred SFI to the network node, the described techniques can be used to enable the network node to consider the preferred SFI in the scheduling of downlink or uplink beam training, as well as in scheduling of slot formats for upcoming slots, which may result in further decreased latency and/or increased reliability for the beam training, as well as decreased latency and/or increased throughput for other communications scheduled in the upcoming slots. Furthermore, by the UE transmitting an indication of a preferred SFI to the network node, the described techniques can be used to enable the UE to influence scheduling of uplink symbols that can be used by the UE for sidelink transmissions, which may decrease latency and/or increase throughput for sidelink communications transmitted by the UE.

In some examples, by the UE transmitting the indication, based at least in part on the one or more trigger conditions, to switch traffic associated with the UE to a companion or neighbor UE associated with the UE, the described techniques can be used to enable switching traffic from one UE to another UE in a multi-device setting when one of the UEs is impacted by certain trigger conditions (e.g., an MPE condition or a blockage condition), which will increase reliability and throughput, and decrease latency, for traffic associated with the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the 3GPP. 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

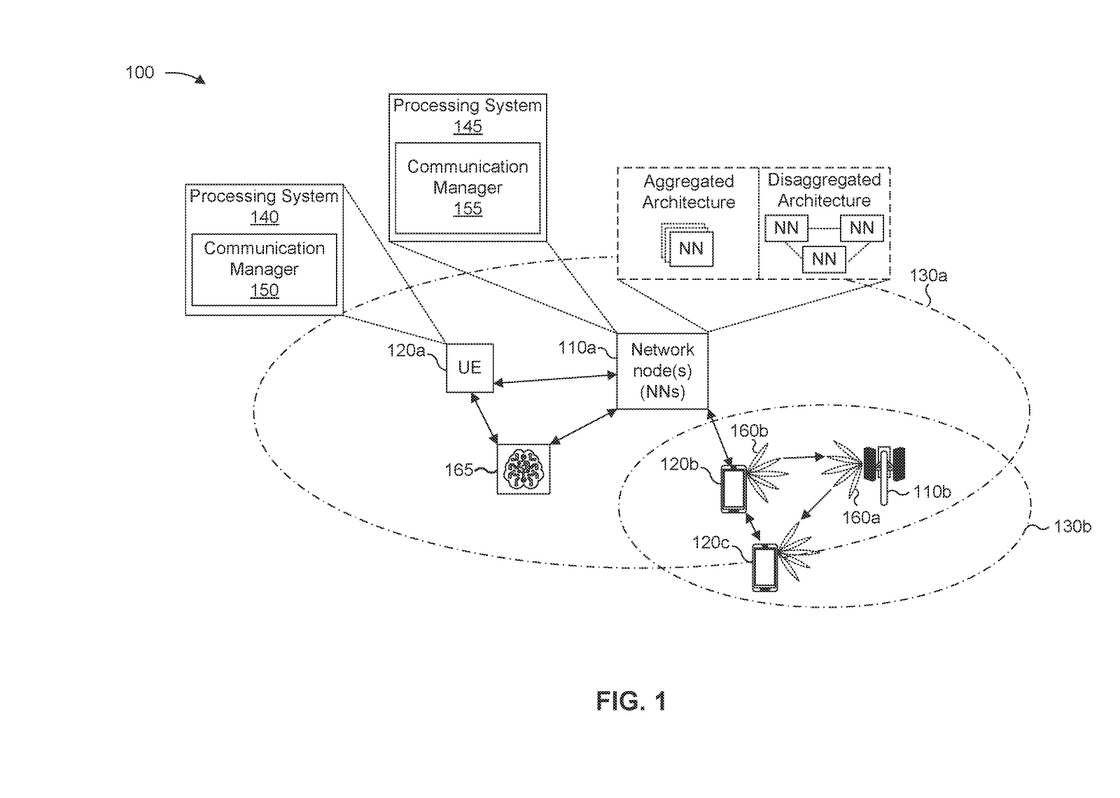

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

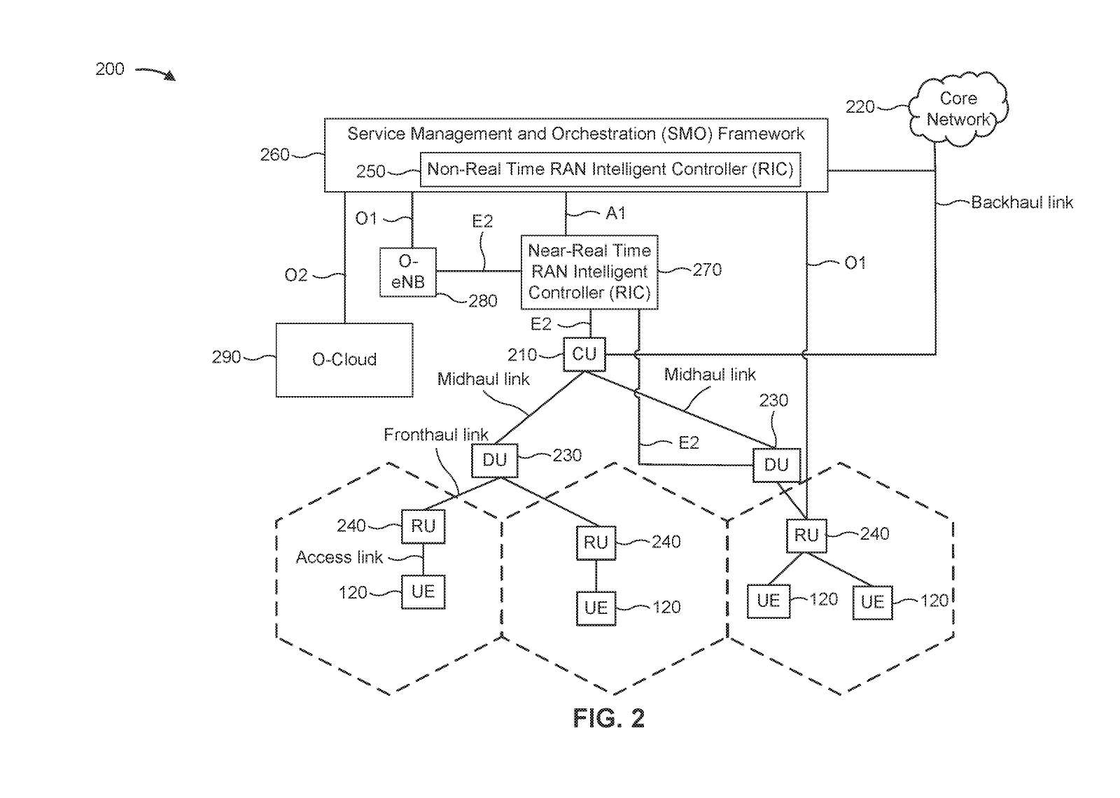

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (SS) (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, SFIs, preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as mTRP operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Further efficiencies in throughput, signal strength, and/or other signal properties may be achieved through beam refinement. For example, the network node 110 may be capable of communicating with the UE 120 using beams (for example, beam(s) 160a) of different beamwidths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the SINR on each of the beams and transmit a beam measurement report (for example, an L1 measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may detect one or more trigger conditions at the UE; and transmit, to a network node, an indication of a preference associated with downlink beam training or uplink beam training, wherein the preference is based at least in part on the one or more trigger conditions at the UE. Additionally, or alternatively, the communication manager 150 may perform one or more other operations described herein.

In some aspects, the network node 110 may include a communication manager 155. As described in more detail elsewhere herein, the communication manager 155 may receive, from a UE, an indication of a preference associated with downlink beam training or uplink beam training; and transmit, to the UE and based at least in part on the indication of the preference, a communication indicating downlink reference signals to be measured for downlink beam training or uplink reference signals to be transmitted for uplink beam training. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

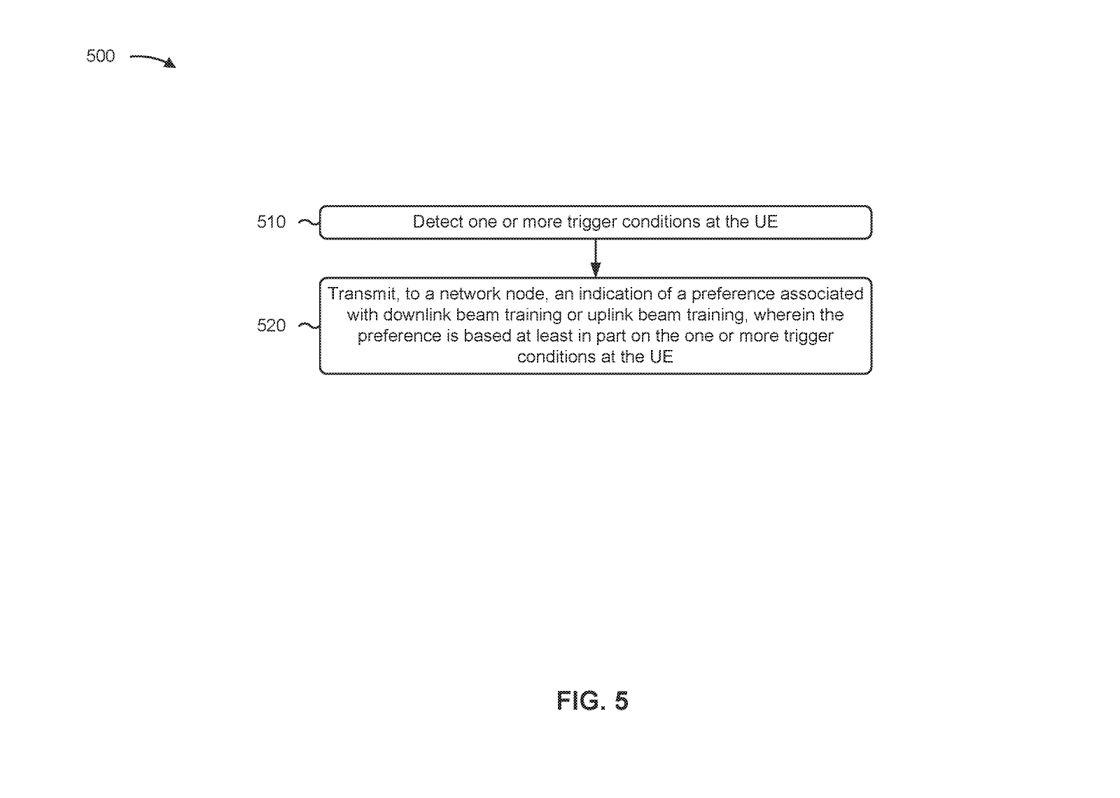

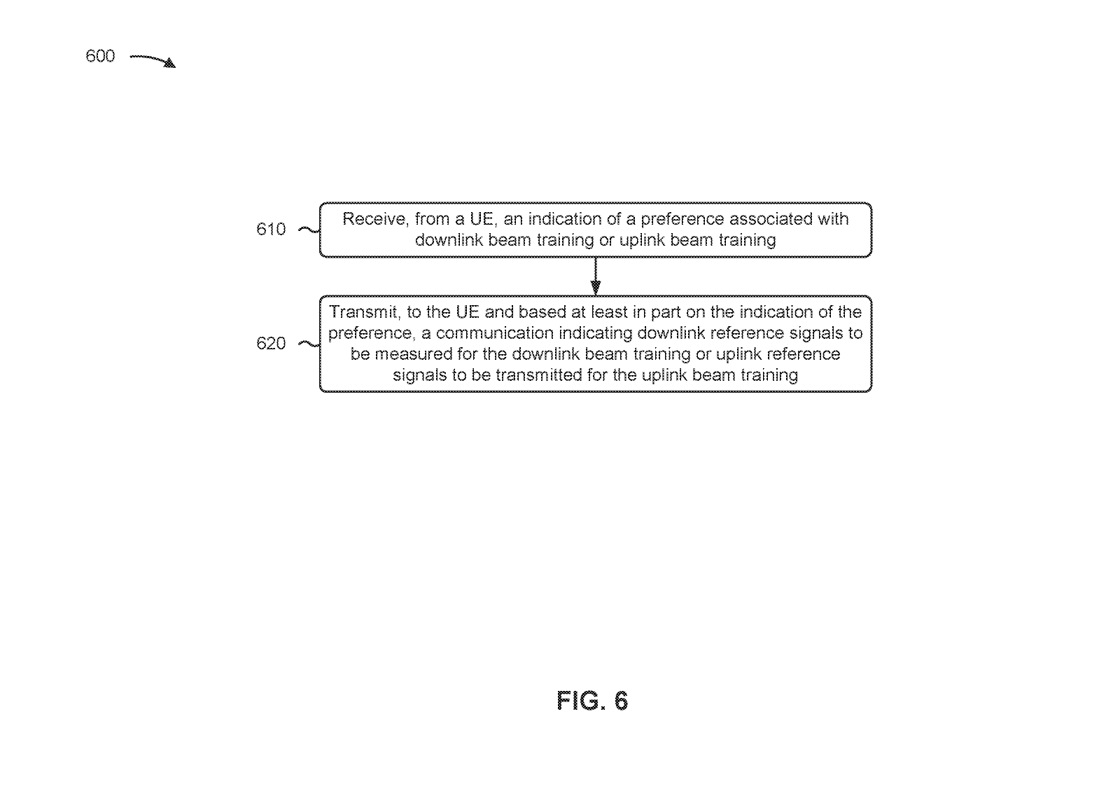

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a UE indication of a preference for downlink or uplink beam training, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

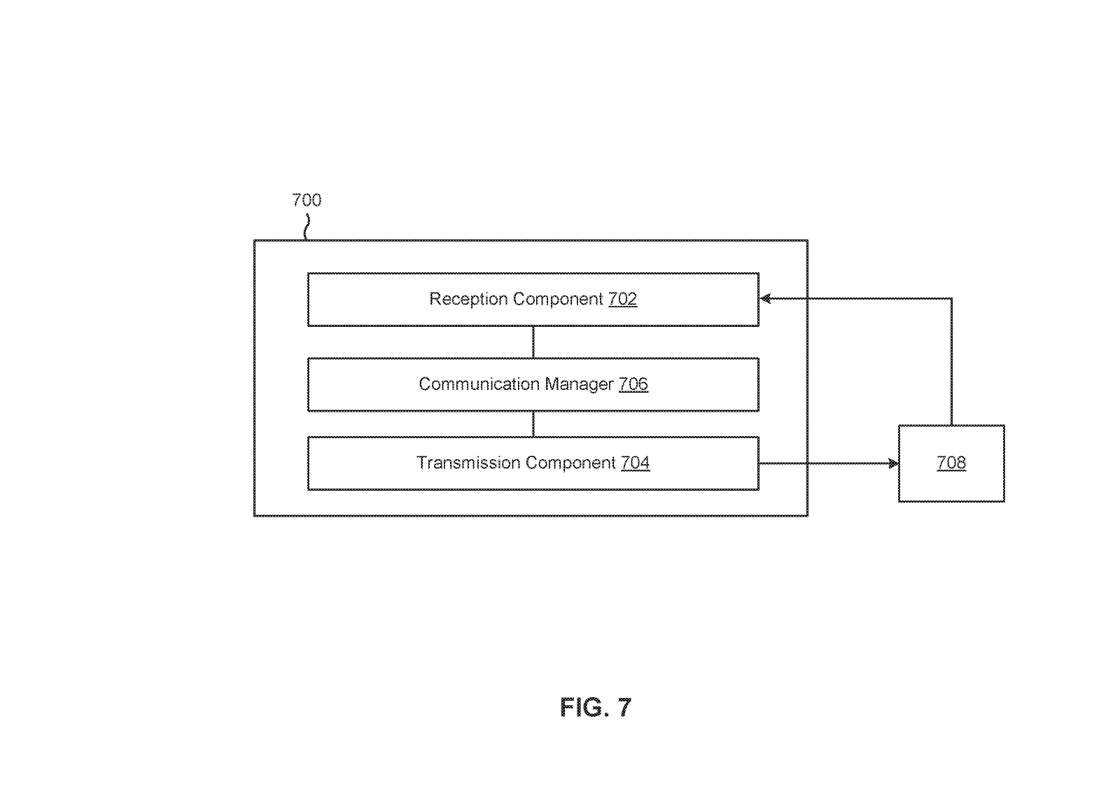

In some aspects, the a UE (e.g., the UE 120) includes means for detecting one or more trigger conditions at the UE (e.g., using communication manager 150, processing system 140, one or more sensors, among other examples); and/or means for transmitting, to a network node, an indication of a preference associated with downlink beam training or uplink beam training, wherein the preference is based at least in part on the one or more trigger conditions at the UE (e.g., using communication manager 150, processing system 140, a radio, one or more RF chains, one or more transceivers, one or more antennas, one or more modems, and/or transmission component 704, among other examples). The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

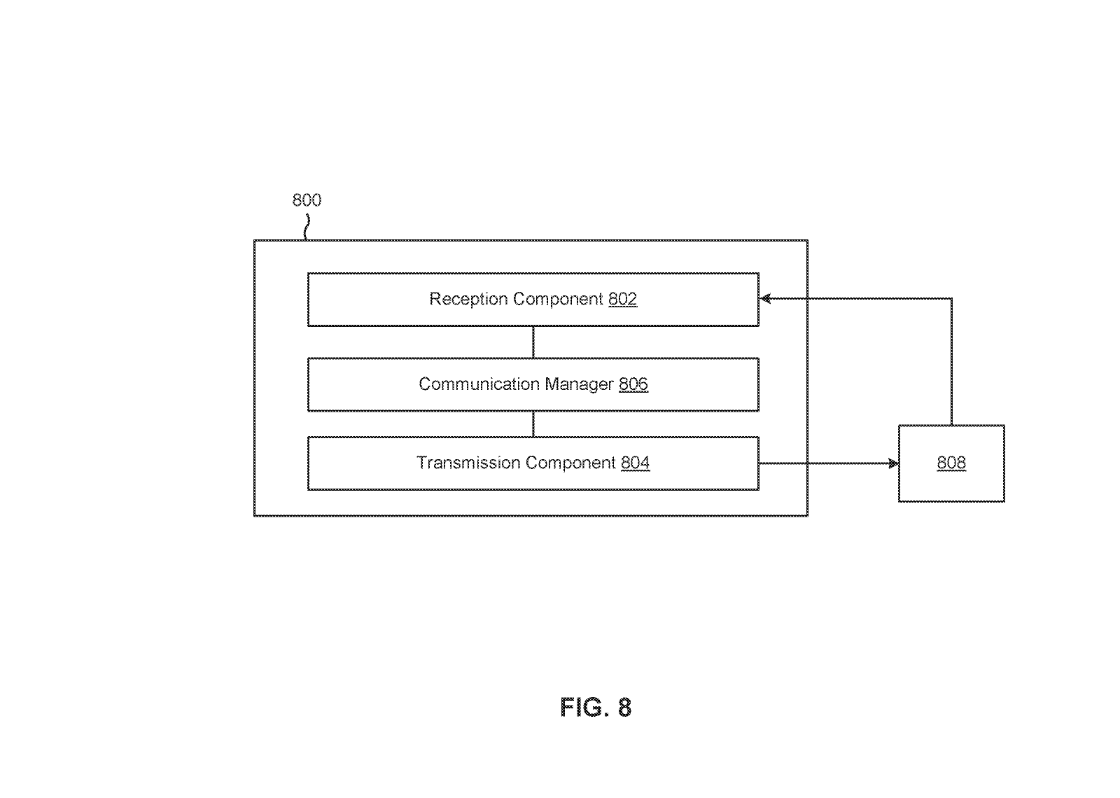

In some aspects, a network node (e.g., the network node 110) includes means for receiving, from a UE, an indication of a preference associated with downlink beam training or uplink beam training (e.g., using communication manager 155, processing system 145, a radio, one or more RF chains, one or more transceivers, one or more antennas, one or more modems, and/or reception component 802, among other examples); and/or means for transmitting, to the UE and based at least in part on the indication of the preference, a communication indicating downlink reference signals to be measured for downlink beam training or uplink reference signals to be transmitted for uplink beam training (e.g., using communication manager 155, processing system 145, a radio, one or more RF chains, one or more transceivers, one or more antennas, one or more modems, and/or transmission component 804, among other examples). The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

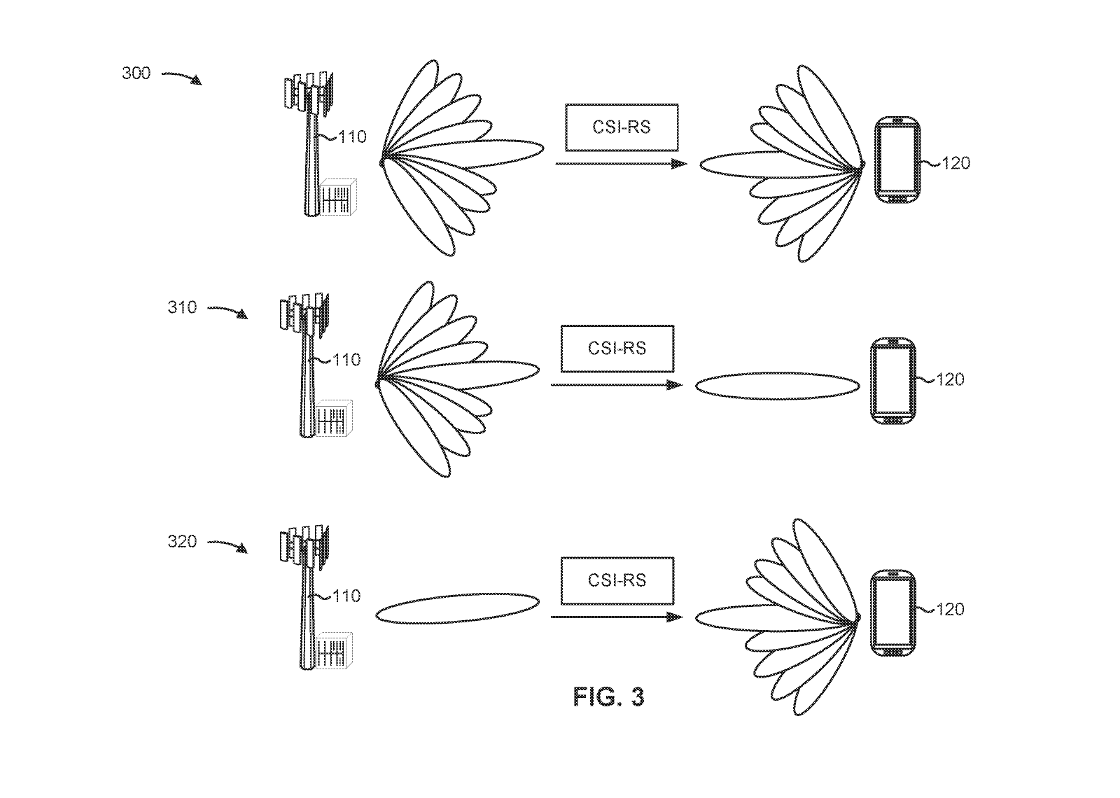

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a network node 110 in a wireless communication network (e.g., wireless communication network 100). However, the devices shown in FIG. 3 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, and/or a CU, among other examples) and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management (e.g., downlink beam training). To enable the UE 120 to perform receive (Rx) beam sweeping, the network node may use a transmit beam to transmit (e.g., with repetitions) each CSI-RS at multiple times within the same CSI-RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use SSBs for beam management in a similar manner as described above.

As shown in FIG. 3, example 310 may include a network node 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 3 and example 310, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same CSI-RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

The first, second, and third beam management procedures depicted in FIG. 3 are examples of downlink beam training (e.g., CSI-RS-based beam training). In some other examples, uplink beam training (e.g., SRS-based beam training) may be used for selection and/or refinement of beams (e.g., transmit and/or receive beams) for the UE and the network node. In such examples, the UE may be configured to transmit SRSs. The network node may perform measurements of the SRSs, and derive the beams to be used by the network node and the UE for communications between the network node and the UE based on the measurements of the SRSs. For example, when there is channel reciprocity between the uplink and the downlink, the network node may derive a beam to use to communicate with the UE (e.g., for both uplink and downlink) and/or a beam for the UE to use to communicate with the network node (e.g., for both uplink and downlink) based on uplink measurements of the SRSs.

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, and/or the UE 120 and the network node 110 may perform a similar beam management procedure to select a UE transmit beam.

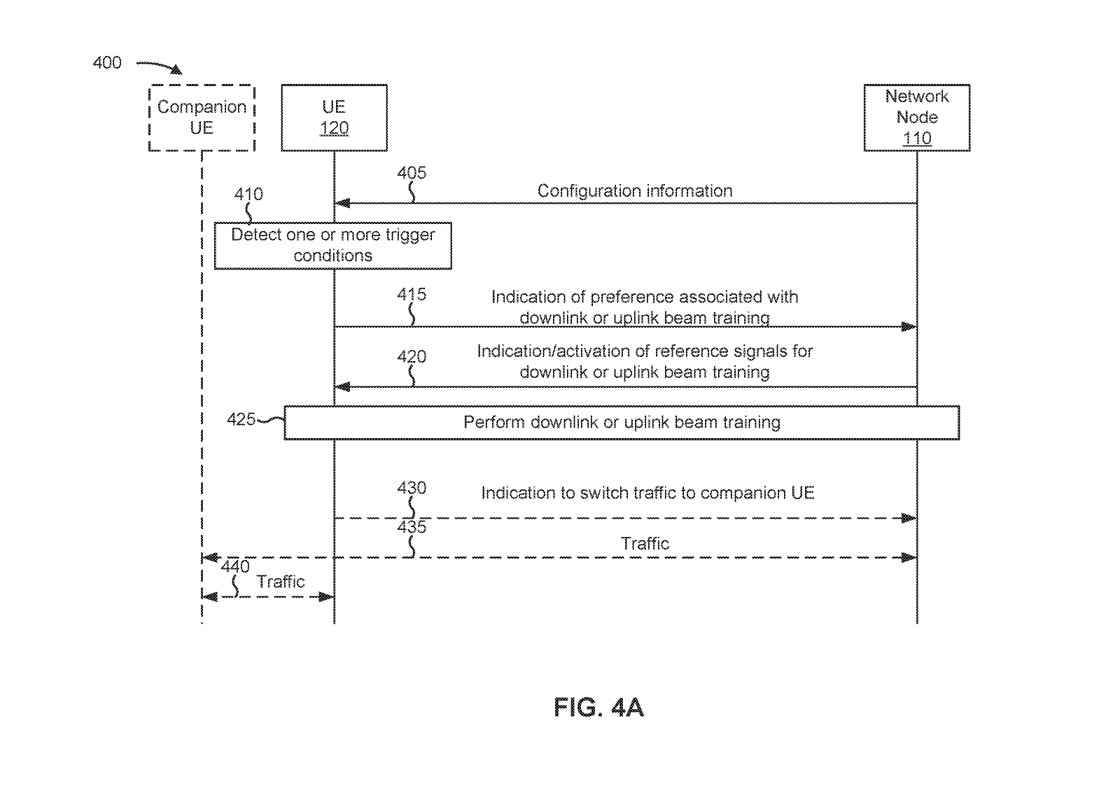

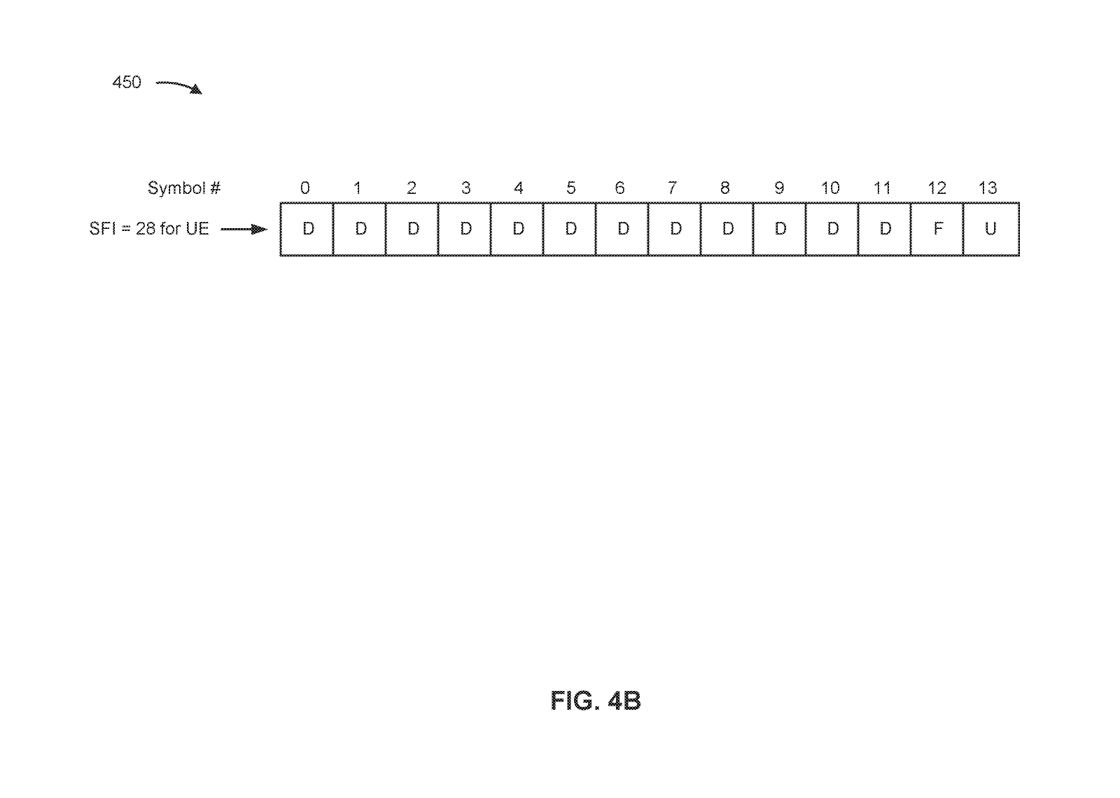

FIGS. 4A-4B are diagrams illustrating examples associated with a UE indication of a preference for downlink or uplink beam training, in accordance with the present disclosure. As shown in FIG. 4A, example 400 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

In some aspects, example 400 may also include communication between the UE 120 and a companion UE (or neighbor UE) associated with the UE 120 and/or communication between the network node 110 and the companion UE (or neighbor UE) associated with the UE 120. In some aspects, the companion UE (or neighbor UE) may be another UE that is associated with the UE 120. For example, the companion UE (or neighbor UE) may be a device associated with (e.g., registered to) a same user as the UE 120 and/or a device within a vicinity of the UE 120. The UE 120 and the companion UE (or neighbor UE) may communicate via sidelink (e.g., 5G/NR sidelink) or another signaling protocol (e.g., Wi-Fi or Bluetooth, among other examples). The network node 110 and the companion UE (or neighbor UE) may communicate via a wireless access link, which may include an uplink and a downlink.

As shown in FIG. 4A, and by reference number 405, the network node 110 may transmit, and the UE 120 may receive, configuration information. In some aspects, the configuration information may be transmitted by the network node 110, and received by the UE 120, via one or more of system information (e.g., a master information block (MIB) and/or a system information block (SIB), among other examples), RRC signaling, one or more MAC-CEs, and/or DCI, among other examples.

In some aspects, the configuration information may include configuration information associated with reporting a preference associated with downlink beam training or uplink beam training. That is, the configuration information may configure reporting, by the UE 120, of a preference associated with downlink beam training or uplink beam training. In some aspects, the configuration information may configure one or more uplink resources (e.g., PUCCH resources and/or PUSCH resources) to be used by the UE 120 for transmitting an indication of a preference associated with downlink beam training or uplink beam training. In some examples, the uplink resources may be dedicated for reporting, by the UE 120, of the preference associated with downlink beam training or uplink beam training. In some other examples, the uplink resources may be uplink resources, configured for the UE 120, that are available for reporting the preference associated with downlink beam training or uplink beam training, but may also be used for other uplink transmissions.

In some aspects, the configuration information may indicate a configured time period for which an indicated preference associated with downlink beam training or uplink beam training is applicable. In some examples, the configuration information may configure periodic reporting of the indication of the preference in accordance with the configured time period. In such examples, the configuration information may indicate periodically occurring uplink resources for reporting the indication of the preference, and the periodically occurring uplink resources may be configured with a periodicity equal to the configured time period.

In some aspects, the configuration information may configure the UE 120 to report one or more preferred SFIs. For example, the configuration information may configure a quantity (K) of preferred SFIs to be reported by the UE 120 (e.g., where K is an integer greater than or equal to 1). That is, the configuration information may indicate a value of K. In some aspects, the configuration information may configure the UE 120 to report one or more non-preferred SFIs. For example, the configuration information may configure a quantity (K) of non-preferred SFIs to be reported by the UE 120 (e.g., where K is an integer greater than or equal to 1). That is, the configuration information may indicate a value of K. In some aspects, the configuration information may configure the UE 120 to report one or more preferred SFIs and/or one or more non-preferred SFIs. For example, the configuration information may indicate a first quantity (K) of preferred SFIs to be reported by the UE 120 and a second quantity (L) of non-preferred SFIs to be reported by the UE 120.

In some aspects, the configuration information may include configuration information associated with the UE 120 indicating to switch traffic associated with the UE 120 to the companion UE (or neighbor UE). For example, the configuration information may configure uplink resources that can be used by the UE 120 to transmit an indication to switch traffic associated with the UE 120 to the companion UE. In some examples, the uplink resources configured for reporting the preference associated with downlink beam training or uplink beam training may also be used by the UE 120 for transmitting an indication to switch traffic associated with the UE 120 to the companion UE.

As further shown in FIG. 4A, and by reference number 410, the UE 120 may detect one or more trigger conditions. In some aspects, the one or more trigger conditions may include one or more operating conditions at the UE 120. For example, the one or more trigger conditions may include one or more operating conditions that may impact uplink beam training and/or downlink beam training for the UE 120. In some aspects, detecting a trigger condition may include monitoring, sensing, measuring, deriving, calculating, estimating, obtaining, receiving an indication of, or otherwise determining the trigger condition. In some aspects, the UE 120 may detect one or more trigger conditions by continuously monitoring the one or more trigger conditions. Additionally, or alternatively, in some aspects, the UE 120 may periodically detect one or more trigger conditions (e.g., in accordance with a configured periodicity for reporting the preference associated with downlink beam training or uplink beam training). In some aspects, the UE 120 may be equipped with one or more sensors (e.g., internal sensors) for measuring/sensing the one or more trigger conditions.

In some aspects the one or more trigger conditions, include an amount of power available at the UE 120. Additionally, or alternatively, the one or more trigger conditions may include a temperature level and/or a thermal overhead measured at the UE 120. Additionally, or alternatively, the one or more trigger conditions may include a downlink EIRP (e.g., an EIRP, at the network node 110, associated with downlink transmission), an uplink EIRP (e.g., an EIRP, at the UE 120, associated uplink transmission), a link budget, and/or a link margin associated with achieving a peak data rate. In some examples, the UE 120 may estimate the downlink EIRP associated with the network node and/or the uplink EIRP associated with the UE based at least in part on measurements with path loss (PL) reference signals (RSs). Additionally, or alternatively, the one or more trigger conditions may include blockage condition at the UE 120. For example, the UE 120 may detect that transmission on one or more beams is constrained by a blockage scenario. Additionally, or alternatively, the one or more trigger conditions may include an MPE condition at the UE 120. For example, the UE 120 may detect whether transmission on one or more beams is constrained by an MPE limit. Additionally, or alternatively, the one or more trigger conditions may include a quantity of antenna modules or antenna panels available at the UE 120. In some aspects, the UE 120 may detect any combination of the trigger conditions described above.

As further shown in FIG. 4A, and by reference number 415, the UE 120 may transmit, and the network node 110 may receive, an indication of a preference associated with downlink beam training or uplink beam training. In some aspects, the UE 120 may transmit the indication of the preference via one or more uplink resources configured in the configuration information. In some aspects, the indication of the preference may be included in UCI or a MAC-CE. In some other aspects, the indication of the preference may be included in RRC signaling.

In some aspects, the indication of the preference may indicate one of the following four choices for the preference: downlink beam training (e.g., CSI-RS-based or SSB-based beam training), uplink beam training (e.g., SRS-based beam training), both downlink beam training (e.g., CSI-RS-based or SSB-based beam training) and uplink beam training (e.g., SRS-based beam training), or neither downlink beam training (e.g., CSI-RS-based beam training) nor uplink beam training (e.g., SRS-based beam training). For example, the indication of the preference may be a two-bit indication that indicates one of the four choices for the preference. The preference may be based on the one or more trigger conditions detected by the UE 120. In some examples, the preference may indicate a dynamic beam training capability (e.g., at a current time) based at least in part on one or more current trigger conditions at the UE 120. For example, the indication (e.g., the two-bit indication) of the preference may indicate a dynamic beam training capability, based at least in part on the current one or more trigger conditions, for downlink beam training alone, uplink beam training alone, both downlink beam training and uplink beam training (e.g., both downlink beam training and uplink beam training are possible for the UE 120 based on the current trigger conditions, and/or the UE 120 does not have a strong preference for downlink beam training or uplink beam training), or neither downlink beam training nor uplink beam training (e.g., neither downlink beam training nor uplink beam training is possible for the UE 120 based on the current trigger conditions).

In some aspects, the preference of the UE 120 may be based at least in part on the amount of power available at the UE 120. For example, the preference may be based at least in part on the amount of power available at the UE 120 and a tradeoff between power needed for transmitting SRSs for uplink beam training and power needed for CSI-RS feedback reporting for downlink beam training. Additionally, or alternatively, the preference of the UE 120 may be based at least in part on thermal considerations, such as a temperature level or measured thermal overhead at the UE 120. For example, a high temperature level (or measured thermal overhead) at the UE 120 may result in non-allowance of a beam training type (e.g., downlink beam training or uplink beam training) that consumes more power (e.g., generates more heat) at the UE 120 (e.g., the preference may be for the beam training type that consumes less power). Additionally, or alternatively, the preference may be based at least in part on a comparison of the downlink EIRP and/or the uplink EIRP versus the link margin needed to achieve a peak data rate (e.g., based on the link budget). For example, in a case in which the UE 120 is in a cell center, the UE 120 may be able to obtain the peak data rate with lower EIRP on uplink than downlink. In this case, the UE 120 may prefer uplink beam training. Additionally, or alternatively, the preference may be based at least in part on a blockage condition or MPE condition detected by the UE 120. For example, the UE 120 may be constrained by a blockage condition or an MPE condition such that the UE 120 may not be able to transmit SRSs for uplink beam training on certain beams. In such examples, transmission of a CRI report for downlink beam training may not be constrained by the blockage condition or the MPE condition. Additionally, or alternatively, the preference may be based at least in part on a quantity of antenna modules/panels available at the UE 120. For example, a larger quantity of antenna modules/panels available at the UE 120 may correspond to a stronger preference for uplink beam training, relative to downlink beam training,

In some aspects, the indication of the preference may be applicable for a configured time period. In some aspects, the configured time period may be indicated in the configuration information. In some examples, the UE 120 may periodically transmit the indication of preference in accordance with a periodicity based on (e.g., equal to) the configured time period. In this case, each transmission of the indication of the preference may indicate a current dynamic preference based at least in part on current trigger conditions detected by the UE 120. In some other aspects, the configured time period may be based at least in part on reporting, by the UE 120, of the preference. In this case, the indication of the preference may indicate the time period.

In some aspects, the indication of the preference may include an indication of a preferred SFI (and/or a non-preferred SFI). For example, the UE 120 may transmit, and the network node 110 may receive, the indication of the preferred SFI (and/or the indication of the non-preferred SFI). In some aspects, the indication of the preferred SFI (and/or the non-preferred SFI) may be the indication of the preference associated with downlink beam training or uplink beam training. For example, the indication of the preferred SFI (and/or the non-preferred SFI) may be transmitted by the UE 120 instead of the two-bit indication described above. In this case, the preferred SFI (and/or the non-preferred SFI) may be indicative of a preference for downlink beam training or uplink beam training. In some other aspects, the indication of the preference may include the two-bit indication described above and the indication the preferred SFI (and/or the non-preferred SFI) (e.g., the indication of the preferred SFI and/or non-preferred SFI may be transmitted by the UE 120 together with the two-bit indication described above).

The one or more trigger conditions that cause the tradeoffs between uplink and downlink beam training may also cause similar tradeoffs for other uplink and downlink communications associated with the UE 120. A slot format for a slot in a cell associated with the network node 110 may be configured by the network node 110 with an SFI. The slot format may assign symbols in a slot as downlink symbols (e.g., symbols dedicated for downlink communication), uplink symbols (e.g., symbols dedicated for uplink communication), or flexible symbols. Different slot formats may be associated with respective SFIs. For example, as shown by reference number 450 in FIG. 4B, SFI = 28 may be associated with a slot format in which symbols 0-11 are downlink symbols (shown as “D”), symbol 12 is a flexible symbol (shown as “F”), and symbol 13 is an uplink symbol (shown as ‘U”). In some examples, the network nodes may allocate different SFIs for different UEs in a network. Accordingly, some UEs may be in a downlink symbol at the same time other UEs are in an uplink symbol. However, there is currently no mechanism in the 3GPP wireless communication standard that allows for a UE (or a collection of UEs) to preempt the SFI indicated by a network node or indicate a preference for a certain SFI.

In some aspects, the UE 120 may transmit, to the network node an indication of one or more preferred SFIs based at least in part on the one or more trigger conditions detected by the UE 120. The one or more preferred SFIs indicated by the UE 120 may be indicative of a preference for downlink beam training or uplink beam training. In some examples, a relative quantity of downlink symbols to uplink symbols in one or more slot formats associated with the one or more preferred SFIs indicated by the UE 120 is indicative of a preference for downlink beam training or uplink beam training. For example, the UE 120 may indicate, to the network node 110, one or more SFIs selected to favor downlink-heavy, downlink-moderate, or downlink-minimal communication modes.

In some aspects, the UE 120 may transmit, to the network node 110, an indication of a top K preferred SFIs (e.g., where K is an integer greater than or equal to one). In some examples, the value for K (e.g., the quantity of preferred SFIs) may be indicated in the configuration information. In some other examples, the value for K may be based at least in part on a recommendation from the UE 120 (e.g., the UE 120 may determine the quantity (K) of preferred SFIs to indicate).

In some aspects, the UE 120 may transmit, to the network node 110, an indication of K non-preferred SFIs (e.g., where K is an integer greater than or equal to one). In some examples, the value for K (e.g., the quantity of non-preferred SFIs) may be indicated in the configuration information. In some other examples, the value for K may be based at least in part on a recommendation from the UE 120 (e.g., the UE 120 may determine the quantity (K) of non-preferred SFIs to indicate).

In some aspects, the UE 120 may transmit, to the network node 110, an indication of one or more preferred SFIs and/or one or more non-preferred SFIs. For example, the UE 120 may transmit, to the network node 110 an indication of K preferred SFIs (e.g., where K is an integer greater than or equal to one) and L non-preferred SFIs (e.g., where L is an integer greater than or equal to one). In some examples, the value for K (e.g., the quantity of preferred SFIs) and the value for L (e.g., the quantity of non-preferred SFIs) may be indicated in the configuration information. In some other examples, the values for K and L may be based at least in part on a recommendation from the UE 120 (e.g., the UE 120 may determine the quantity (K) of preferred SFIs to indicate and the quantity (L) of non-preferred SFIs to indicate).

Returning to FIG. 4A, as shown by reference number 420, the network node 110 may transmit, and the UE 120 may receive, a communication indicating reference signals for downlink beam training or uplink beam training. For example, the network node 110 may transmit, and the UE 120 may receive, a communication indicating downlink reference signals (e.g., CSI-RSs) to be measured by the UE 120 for downlink beam training or uplink reference signals (e.g., SRSs) to be transmitted by the UE 120 for uplink beam training.

In some aspects, the communication may indicate a configuration of reference signals for the UE 120 for downlink beam training or uplink beam training. For example, the communication may indicate a configuration of downlink reference signals (e.g., CSI-RSs) to be measured by the UE 120 for downlink beam training, or the communication may indicate a configuration of uplink reference signals (e.g., SRSs) to be transmitted by the UE 120 for uplink beam training. In some other aspects, the communication may indicate activation or triggering of reference signals already configured for the UE 120 for downlink beam training or uplink beam training. For example, the communication may indicate activation or triggering of downlink reference signals (e.g., CSI-RSs) configured for the UE 120 for downlink beam training, or the communication may indicate activation or triggering of uplink reference signals (e.g., SRSs) configured for the UE 120 for uplink beam training.

In some aspects, the communication indicating the reference signals for downlink beam training or uplink beam training may be based at least in part on the indication of the preference associated with downlink beam training or uplink beam training transmitted by the UE 120. For example, the network node 110 may determine whether downlink beam training or uplink beam training is to be performed for the UE 120 based at least in part on the indication of the preference received from the UE 120. In some examples, the network node 110 may determine whether downlink beam training or uplink beam training is to be performed for the UE 120 based at least in part on the indication of the preference received from the UE 120 and based at least in part on other considerations at the network node 110. For example, the other considerations at the network node 110 may include other indications of preferences received from one or more other UEs, network conditions in the cell associated with the network node 110, and/or operating conditions at the network node 110, among other examples.

In some aspects, in a case in which the indication of the preference received from the UE 120 includes the indication of one or more preferred SFIs (and/or non-preferred SFIs), the network node 110 may determine whether downlink beam training or uplink beam training is to be performed for the UE 120 based at least in part on the indication of the one or more preferred SFIs (and/or non-preferred SFIs). Additionally, or alternatively, in some aspects, the network node 110 may transmit, and the UE 120 may receive an indication of one or more SFIs selected for one or more slots based at least in part on the indication of the one or more preferred SFIs (and/or non-preferred SFIs) received from the UE 120. In some aspects, the network node 110 may consider the indication of the preferred SFIs received from the UE 120, other indications of preferred SFIs received from other UEs in the cell, scheduling and/or traffic requirements of the UE 120 and the other UEs in the cell, and/or coordination with one or more neighboring network nodes to reduce cross-link interference, among other examples when selecting the SFIs for the one or more slots. In some aspects, certain UEs (e.g., the UE 120 and/or one or more other UEs) may be considered a premium tier of UEs, and the network node 110 may give the preferred SFIs indicated by the UEs in the premium tier of UEs more weight (e.g., as compared with UEs not in the premium tier of UEs) in the selection of the SFIs for the one or more slots. In some aspects, in addition to (or instead of) being indicative of the preference for downlink beam training or uplink beam training, the indication of the preferred SFIs received from a UE (e.g., the UE 120 or another UE in the cell) may be utilized to influence to network node 110 to select SFIs that enable increased sidelink communication opportunities for the UE (e.g., via SFIs associated with slot formats with more uplink symbols). In this case, the network node 110 may transmit an indication of one or more SSIs associated with slot formats with an increased quantity of uplink symbols, and the UE (e.g., the UE 120 or another UE) may utilize the uplink symbols for transmitting sidelink communications.

As further shown in FIG. 4A, and by reference number 425, the UE 120 and the network node 110 may perform downlink beam training or uplink beam training. In some aspects, the UE 120 and the network node 110 may perform downlink beam training in connection with the communication, transmitted by the network node 110, indicating downlink reference signals (e.g., CSI-RSs) to be measured by the UE 120 for downlink beam training. In this case, the network node 110 may transmit the downlink reference signals (e.g., CSI-RSs), and the UE 120 may perform measurements of the downlink reference signals (e.g., CSI-RSs) and transmit, to the network node 110, a CSI-RS report indicating the measurements and/or CSI determined based on the measurements. The network node 110 may select or refine beams to be used by the network node 110 and the UE 120 based at least in part on the CSI-report, and the network node 110 may transmit, to the UE 120 and indication of a beam to be used by the UE 120.

In some other aspects, the UE 120 and the network node 110 may perform uplink beam training in connection with the communication, transmitted by the network node 110, indicating uplink reference signals (e.g., SRSs) to be transmitted by the UE 120 for uplink beam training. In this case, the UE 120 may transmit the uplink reference signals (e.g., SRSs), and the network node 110 may perform measurements of the uplink reference signals (e.g., SRSs). The network node 110 may select (e.g., derive) or refine beams to be used by the network node 110 and the UE 120 based at least in part on the measurements, and the network node 110 may transmit, to the UE 120 and indication of a beam to be used by the UE 120.

As further shown in FIG. 4A, and by reference number 430, in some aspects, the UE 120 may transmit, and the network node 110 may receive, an indication to switch traffic associated with the UE 120 to the companion UE (or neighbor UE) associated with the UE 120. In some aspects, the downlink associated with the UE 120 may include downlink traffic to be transmitted, by the network node 110, to the UE 120 and/or uplink traffic to be received, by the network node 110, from the UE 120. In some aspects, the UE 120 may transmit the indication to switch the traffic associated with the UE 120 to the companion UE (or neighbor UE) based at least in part on the one or more trigger conditions detected by the UE 120. For example, the UE 120 may transmit the indication to switch the traffic associated with the UE 120 to the companion UE (or neighbor UE) based at least in part on detecting a blockage condition or an MPE condition (e.g., an MPE limitation constraining communication by the UE 120) at the UE 120. In some examples, the UE 120 may transmit the indication to switch the traffic associated with the UE 120 to the companion UE (or neighbor UE) based at least in part on detecting a blockage condition or an MPE condition at the UE 120, and the UE 120 or the companion UE detecting no blockage condition or MPE condition (e.g., MPE limitations) at the companion UE.

In some aspects, the UE 120 may transmit the indication to switch the traffic associated with the UE 120 to the companion UE (or neighbor UE) together with the indication of the preference associated with downlink beam training or uplink beam training. For example, the indication to switch the traffic associated with the UE 120 to the companion UE (or neighbor UE) may be included in a same communication as the indication of the preference associated with downlink beam training or uplink beam training. In some other aspects, the UE 120 may transmit the indication to switch the traffic associated with the UE 120 to the companion UE (or neighbor UE) independently of the indication of the preference associated with downlink beam training or uplink beam training, or the UE 120 may transmit the indication to switch the traffic associated with the UE 120 to the companion UE (or neighbor UE) instead of the indication of the preference associated with downlink beam training or uplink beam training (e.g., in an uplink resource configured for the indication of the preference associated with downlink beam training or uplink beam training).

As further shown in FIG. 4A, and by reference number 435, the network node 110 may communicate, with the companion UE (or neighbor UE), traffic associated with the UE 120. The network node 110 may communicate, with the companion UE (or neighbor UE), the traffic associated with the UE 120 in connection with the network node 110 receiving the indication to switch the traffic associated with the UE 120 to the companion UE (or neighbor UE). For example, the network node 110 may transmit, and the companion UE (or neighbor UE) may receive, downlink traffic associated with the UE 120 (e.g., downlink traffic destined for the UE 120). Additionally, or alternatively, the companion UE (or neighbor UE) may transmit, and the network node 110 may receive, uplink traffic associated with the UE 120 (e.g., uplink traffic originating from the UE 120).

As further shown in FIG. 4A, and by reference number 440, the UE 120 may communicate, with the companion UE (or neighbor UE), the traffic associated with the UE 120. The UE 120 may communicate, with the companion UE (or neighbor UE), the traffic associated with the UE 120 in connection with the UE 120 transmitting the indication to switch the traffic associated with the UE 120 to the companion UE (or neighbor UE). For example, the UE 120 may transmit, and the companion UE (or neighbor UE) may receive, uplink traffic associated with the UE 120 (e.g., uplink traffic originating from the UE 120 to be transmitted by the companion UE to the network node 110). Additionally, or alternatively, the companion UE (or neighbor UE) may transmit, and the UE 120 may receive, downlink traffic associated with the UE 120 (e.g., downlink traffic destined for the UE 120 that is received by the companion UE from the network node 110). In some examples, the UE 120 and the companion UE (or neighbor UE) may communicate the traffic via one or more sidelink communications or via another wireless communication protocol (e.g., Wi-Fi or Bluetooth, among other examples).

As indicated above, FIGS. 4A-4B are provided as examples. Other examples may differ from what is described with respect to FIGS. 4A-4B.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with a UE indication of a preference for downlink or uplink beam training.

As shown in FIG. 5, in some aspects, process 500 may include detecting one or more trigger conditions at the UE (block 510). For example, the UE (e.g., using communication manager 706, depicted in FIG. 7) may detect one or more trigger conditions at the UE, as described above, for example, with reference to FIGS. 4A-4B.

As further shown in FIG. 5, in some aspects, process 500 may include transmitting, to a network node, an indication of a preference associated with downlink beam training or uplink beam training, wherein the preference is based at least in part on the one or more trigger conditions at the UE (block 520). For example, the UE (e.g., using communication manager 706 and/or transmission component 704, depicted in FIG. 7) may transmit, to a network node, an indication of a preference associated with downlink beam training or uplink beam training, wherein the preference is based at least in part on the one or more trigger conditions at the UE, as described above, for example, with reference to FIGS. 4A-4B.

Process 500 may include additional aspects, such as any single aspect or any combination of aspects described below and/or in connection with one or more other processes described elsewhere herein.

In a first aspect, process 500 includes receiving configuration information associated with reporting the preference, wherein the configuration information indicates one or more uplink resources for transmitting the indication of the preference.

In a second aspect, alone or in combination with the first aspect, the indication of the preference indicates a preference for downlinking beam training, uplink beam training, both downlink beam training and uplink beam training, or neither downlink beam training nor uplink beam training.

In a third aspect, alone or in combination with one or more of the first and second aspects, the indication of the preference is a two-bit indication.

In a fourth aspect, alone or in combination with one or more of the first through third aspects, the indication of the preference indicates a dynamic beam training capability for the UE, based at least in part on the one or more trigger conditions at the UE, for downlinking beam training alone, uplink beam training alone, both downlink beam training and uplink beam training, or neither downlink beam training nor uplink beam training.

In a fifth aspect, alone or in combination with one or more of the first through fourth aspects, the preference is applicable for a configured time period.

In a sixth aspect, alone or in combination with one or more of the first through fifth aspects, process 500 includes receiving configuration information indicating the configured time period.

In a seventh aspect, alone or in combination with one or more of the first through sixth aspects, the configuration information configures periodic reporting of the indication of the preference in accordance with the configured time period.

In an eighth aspect, alone or in combination with one or more of the first through seventh aspects, the indication of the preference indicates the configured time period.

In a ninth aspect, alone or in combination with one or more of the first through eighth aspects, the one or more trigger conditions include an amount of power available at the UE, a temperature level or measured thermal overhead at the UE, an EIRP at the network node associated with downlink transmission, an EIRP at the UE associated with uplink transmission, a link budget, an MPE condition at the UE, a blockage condition at the UE, a quantity of antenna modules or antenna panels available at the UE, or any combination thereof.

In a tenth aspect, alone or in combination with one or more of the first through ninth aspects, process 500 includes receiving, based at least in part on the indication of the preference, a communication indicating downlink reference signals to be measured for downlink beam training or uplink reference signals to be transmitted for uplink beam training.

In an eleventh aspect, alone or in combination with one or more of the first through tenth aspects, the downlink reference signals are CSI-RSs, and the uplink reference signals are SRSs.

In a twelfth aspect, alone or in combination with one or more of the first through eleventh aspects, the indication of the preference includes an indication of a preferred SFI.

In a thirteenth aspect, alone or in combination with one or more of the first through twelfth aspects, a relative quantity of downlink symbols to uplink symbols in a slot format associated with the preferred SFI is indicative of the preference associated with downlink beam training or uplink beam training.

In a fourteenth aspect, alone or in combination with one or more of the first through thirteenth aspects, the indication of the preference includes an indication of K preferred SFIs, where K is an integer greater than or equal to 1.

In a fifteenth aspect, alone or in combination with one or more of the first through fourteenth aspects, process 500 includes receiving configuration information indicating a value of K.

In a sixteenth aspect, alone or in combination with one or more of the first through fifteenth aspects, the indication of the preference includes an indication of K non-preferred SFIs, where K is an integer greater than or equal to 1.

In a seventeenth aspect, alone or in combination with one or more of the first through sixteenth aspects, process 500 includes receiving configuration information indicating a value of K.

In an eighteenth aspect, alone or in combination with one or more of the first through seventeenth aspects, the indication of the preference includes an indication of one or more preferred SFIs and an indication of one or more non-preferred SFIs.

In a nineteenth aspect, alone or in combination with one or more of the first through eighteenth aspects, process 500 includes transmitting, to the network node and based at least in part on the one or more trigger conditions, an indication to switch traffic associated with the UE to a companion or neighbor UE associated with the UE.

In a twentieth aspect, alone or in combination with one or more of the first through nineteenth aspects, the indication to switch the traffic associated with the UE to the companion or neighbor UE is included in a same communication with the indication of the preference.

In a twenty-first aspect, alone or in combination with one or more of the first through twentieth aspects, the one or more trigger conditions includes at least one of a blockage condition at the UE or an MPE condition at the UE, and the indication to switch the traffic associated with the UE to the companion or neighbor UE is based at least in part on the at least one of the blockage condition at the UE or the MPE condition at the UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with a UE indication of a preference for downlink or uplink beam training.

As shown in FIG. 6, in some aspects, process 600 may include receiving, from a UE, an indication of a preference associated with downlink beam training or uplink beam training (block 610). For example, the network node (e.g., using communication manager 806 and/or reception component 802, depicted in FIG. 8) may receive, from a UE, an indication of a preference associated with downlink beam training or uplink beam training, as described above, for example, with reference to FIGS. 4A-4B.

As further shown in FIG. 6, in some aspects, process 600 may include transmitting, to the UE and based at least in part on the indication of the preference, a communication indicating downlink reference signals to be measured for downlink beam training or uplink reference signals to be transmitted for uplink beam training (block 620). For example, the network node (e.g., using communication manager 806 and/or transmission component 804, depicted in FIG. 8) may transmit, to the UE and based at least in part on the indication of the preference, a communication indicating downlink reference signals to be measured for downlink beam training or uplink reference signals to be transmitted for uplink beam training, as described above, for example, with reference to FIGS. 4A-4B.

Process 600 may include additional aspects, such as any single aspect or any combination of aspects described below and/or in connection with one or more other processes described elsewhere herein.

In a first aspect, process 600 includes transmitting configuration information associated with reporting the preference, wherein the configuration information indicates one or more uplink resources to be used by the UE for transmitting the indication of the preference.

In a second aspect, alone or in combination with the first aspect, the indication of the preference indicates a preference for downlinking beam training, uplink beam training, both downlink beam training and uplink beam training, or neither downlink beam training nor uplink beam training.

In a third aspect, alone or in combination with one or more of the first and second aspects, the indication of the preference is a two-bit indication.

In a fourth aspect, alone or in combination with one or more of the first through third aspects, the indication of the preference indicates a dynamic beam training capability for the UE, based at least in part on one or more trigger conditions at the UE, for downlinking beam training alone, uplink beam training alone, both downlink beam training and uplink beam training, or neither downlink beam training nor uplink beam training.

In a fifth aspect, alone or in combination with one or more of the first through fourth aspects, the preference is applicable for a configured time period.

In a sixth aspect, alone or in combination with one or more of the first through fifth aspects, process 600 includes transmitting configuration information indicating the configured time period.

In a seventh aspect, alone or in combination with one or more of the first through sixth aspects, the configuration information configures periodic reporting of the indication of the preference in accordance with the configured time period.

In an eighth aspect, alone or in combination with one or more of the first through seventh aspects, the indication of the preference indicates the configured time period.

In a ninth aspect, alone or in combination with one or more of the first through eighth aspects, the preference is based at least in part on one or more trigger conditions at the UE, and the one or more trigger conditions include an amount of power available at the UE, a temperature level or measured thermal overhead at the UE, an EIRP at the network node associated with downlink transmission, an EIRP at the UE associated with uplink transmission, a link budget, an MPE condition at the UE, a blockage condition at the UE, a quantity of antenna modules or antenna panels available at the UE, or any combination thereof.

In a tenth aspect, alone or in combination with one or more of the first through ninth aspects, the downlink reference signals are CSI-RSs, and the uplink reference signals are SRSs.

In an eleventh aspect, alone or in combination with one or more of the first through tenth aspects, the indication of the preference includes an indication of a preferred SFI.

In a twelfth aspect, alone or in combination with one or more of the first through eleventh aspects, a relative quantity of downlink symbols to uplink symbols in a slot format associated with the preferred SFI is indicative of the preference associated with downlink beam training or uplink beam training.

In a thirteenth aspect, alone or in combination with one or more of the first through twelfth aspects, the indication of the preference includes an indication of K preferred SFIs, where K is an integer greater than or equal to 1.

In a fourteenth aspect, alone or in combination with one or more of the first through thirteenth aspects, process 600 includes transmitting configuration information indicating a value of K.

In a fifteenth aspect, alone or in combination with one or more of the first through fourteenth aspects, the indication of the preference includes an indication of K non-preferred SFIs, where K is an integer greater than or equal to 1.

In a sixteenth aspect, alone or in combination with one or more of the first through fifteenth aspects, process 600 includes transmitting configuration information indicating a value of K.

In a seventeenth aspect, alone or in combination with one or more of the first through sixteenth aspects, the indication of the preference includes an indication of one or more preferred SFIs and an indication of one or more non-preferred SFIs.

In an eighteenth aspect, alone or in combination with one or more of the first through seventeenth aspects, process 600 includes receiving an indication to switch traffic associated with the UE to a companion or neighbor UE associated with the UE.

In a nineteenth aspect, alone or in combination with one or more of the first through eighteenth aspects, the indication to switch the traffic associated with the UE to the companion or neighbor UE is included in a same communication with the indication of the preference.

In a twentieth aspect, alone or in combination with one or more of the first through nineteenth aspects, the indication to switch the traffic associated with the UE to the companion or neighbor UE is based at least in part on at least one of a blockage condition at the UE or an MPE condition at the UE.

In a twenty-first aspect, alone or in combination with one or more of the first through twentieth aspects, process 600 includes communicating, with the companion or neighbor UE, the traffic associated with the UE in connection with receiving the indication to switch the traffic associated with the UE to the companion or neighbor UE

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4B. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may detect one or more trigger conditions at the UE. The transmission component 704 may transmit, to a network node, an indication of a preference associated with downlink beam training or uplink beam training, wherein the preference is based at least in part on the one or more trigger conditions at the UE.

The reception component 702 may receive configuration information associated with reporting the preference, wherein the configuration information indicates one or more uplink resources for transmitting the indication of the preference.

The reception component 702 may receive configuration information indicating the configured time period.

The reception component 702 may receive, based at least in part on the indication of the preference, a communication indicating downlink reference signals to be measured for downlink beam training or uplink reference signals to be transmitted for uplink beam training.

The reception component 702 may receive configuration information indicating a value of K.

The transmission component 704 may transmit, to the network node and based at least in part on the one or more trigger conditions, an indication to switch traffic associated with the UE to a companion or neighbor UE associated with the UE.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4B. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a UE, an indication of a preference associated with downlink beam training or uplink beam training. The transmission component 804 may transmit, to the UE and based at least in part on the indication of the preference, a communication indicating downlink reference signals to be measured for downlink beam training or uplink reference signals to be transmitted for uplink beam training.

The transmission component 804 may transmit configuration information associated with reporting the preference, wherein the configuration information indicates one or more uplink resources to be used by the UE for transmitting the indication of the preference.

The transmission component 804 may transmit configuration information indicating the configured time period.

The transmission component 804 may transmit configuration information indicating a value of K.

The reception component 802 may receive an indication to switch traffic associated with the UE to a companion or neighbor UE associated with the UE.

The reception component 802 and/or the transmission component 804 may communicate, with the companion or neighbor UE, the traffic associated with the UE in connection with receiving the indication to switch the traffic associated with the UE to the companion or neighbor UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: detecting one or more trigger conditions at the UE; and transmitting, to a network node, an indication of a preference associated with downlink beam training or uplink beam training, wherein the preference is based at least in part on the one or more trigger conditions at the UE.

Aspect 2: The method of Aspect 1, further comprising: receiving configuration information associated with reporting the preference, wherein the configuration information indicates one or more uplink resources for transmitting the indication of the preference.

Aspect 3: The method of any of Aspects 1-2, wherein the indication of the preference indicates a preference for: downlink beam training, uplink beam training, both downlink beam training and uplink beam training, or neither downlink beam training nor uplink beam training.

Aspect 4: The method of Aspect 3, wherein the indication of the preference is a two-bit indication.

Aspect 5: The method of any of Aspects 1-4, wherein the indication of the preference indicates a dynamic beam training capability for the UE, based at least in part on the one or more trigger conditions at the UE, for: downlink beam training alone, uplink beam training alone, both downlink beam training and uplink beam training, or neither downlink beam training nor uplink beam training.

Aspect 6: The method of any of Aspects 1-5, wherein the preference is applicable for a configured time period.

Aspect 7: The method of Aspect 6, further comprising: receiving configuration information indicating the configured time period.

Aspect 8: The method of Aspect 7, wherein the configuration information configures periodic reporting of the indication of the preference in accordance with the configured time period.

Aspect 9: The method of Aspect 6, wherein the indication of the preference indicates the configured time period.

Aspect 10: The method of any of Aspects 1-9, wherein the one or more trigger conditions include: an amount of power available at the UE, a temperature level or measured thermal overhead at the UE, an equivalent isotropic radiated power (EIRP) at the network node associated with downlink transmission, an EIRP at the UE associated with uplink transmission, a link budget, a maximum permissible exposure (MPE) condition at the UE, a blockage condition at the UE, a quantity of antenna modules or antenna panels available at the UE, or any combination thereof.

Aspect 11: The method of any of Aspects 1-10, further comprising: receiving, based at least in part on the indication of the preference, a communication indicating downlink reference signals to be measured for downlink beam training or uplink reference signals to be transmitted for uplink beam training.

Aspect 12: The method of Aspect 11, wherein the downlink reference signals are channel state information reference signals (CSI-RSs), and wherein the uplink reference signals are sounding reference signals (SRSs).

Aspect 13: The method of any of Aspects 1-12, wherein the indication of the preference includes an indication of a preferred slot format indicator (SFI).

Aspect 14: The method of Aspect 13, wherein a relative quantity of downlink symbols to uplink symbols in a slot format associated with the preferred SFI is indicative of the preference associated with downlink beam training or uplink beam training.

Aspect 15: The method of any of Aspects 1-14, wherein the indication of the preference includes an indication of K preferred slot format indicators (SFIs), wherein K is an integer greater than or equal to 1.

Aspect 16: The method of Aspect 15, further comprising: receiving configuration information indicating a value of K.

Aspect 17: The method of any of Aspects 1-16, wherein the indication of the preference includes an indication of K non-preferred slot format indicators (SFIs), wherein K is an integer greater than or equal to 1.

Aspect 18: The method of Aspect 17, further comprising: receiving configuration information indicating a value of K.

Aspect 19: The method of any of Aspects 1-18, wherein the indication of the preference includes an indication of one or more preferred slot format indicators (SFIs) and an indication of one or more non-preferred SFIs.

Aspect 20: The method of any of Aspects 1-19, further comprising: transmitting, to the network node and based at least in part on the one or more trigger conditions, an indication to switch traffic associated with the UE to a companion or neighbor UE associated with the UE.

Aspect 21: The method of Aspect 20, wherein the indication to switch the traffic associated with the UE to the companion or neighbor UE is included in a same communication with the indication of the preference.

Aspect 22: The method of any of Aspects 20-21, wherein the one or more trigger conditions includes at least one of a blockage condition at the UE or a maximum permissible exposure (MPE) condition at the UE, and wherein the indication to switch the traffic associated with the UE to the companion or neighbor UE is based at least in part on the at least one of the blockage condition at the UE or the MPE condition at the UE.

Aspect 23: A method of wireless communication performed by a network node, comprising: receiving, from a user equipment (UE), an indication of a preference associated with downlink beam training or uplink beam training; and transmitting, to the UE and based at least in part on the indication of the preference, a communication indicating downlink reference signals to be measured for downlink beam training or uplink reference signals to be transmitted for uplink beam training.

Aspect 24: The method of Aspect 23, further comprising: transmitting configuration information associated with reporting the preference, wherein the configuration information indicates one or more uplink resources to be used by the UE for transmitting the indication of the preference.

Aspect 25: The method of any of Aspects 23-24, wherein the indication of the preference indicates a preference for: downlink beam training, uplink beam training, both downlink beam training and uplink beam training, or neither downlink beam training nor uplink beam training.

Aspect 26: The method of Aspect 25, wherein the indication of the preference is a two-bit indication.

Aspect 27: The method of any of Aspects 23-26, wherein the indication of the preference indicates a dynamic beam training capability for the UE, based at least in part on one or more trigger conditions at the UE, for: downlink beam training alone, uplink beam training alone, both downlink beam training and uplink beam training, or neither downlink beam training nor uplink beam training.

Aspect 28: The method of any of Aspects 23-27, wherein the preference is applicable for a configured time period.

Aspect 29: The method of Aspect 28, further comprising: transmitting configuration information indicating the configured time period.

Aspect 30: The method of Aspect 29, wherein the configuration information configures periodic reporting of the indication of the preference in accordance with the configured time period.

Aspect 31: The method of Aspect 28, wherein the indication of the preference indicates the configured time period.

Aspect 32: The method of any of Aspects 23-31, wherein the preference is based at least in part on one or more trigger conditions at the UE, and wherein the one or more trigger conditions include: an amount of power available at the UE, a temperature level or measured thermal overhead at the UE, an equivalent isotropic radiated power (EIRP) at the network node associated with downlink transmission, an EIRP at the UE associated with uplink transmission, a link budget, a maximum permissible exposure (MPE) condition at the UE, a blockage condition at the UE, a quantity of antenna modules or antenna panels available at the UE, or any combination thereof.

Aspect 33: The method of any of Aspects 23-32, wherein the downlink reference signals are channel state information reference signals (CSI-RSs), and wherein the uplink reference signals are sounding reference signals (SRSs).

Aspect 34: The method of any of Aspects 23-33, wherein the indication of the preference includes an indication of a preferred slot format indicator (SFI).

Aspect 35: The method of Aspect 34, wherein a relative quantity of downlink symbols to uplink symbols in a slot format associated with the preferred SFI is indicative of the preference associated with downlink beam training or uplink beam training.

Aspect 36: The method of any of Aspects 23-35, wherein the indication of the preference includes an indication of K preferred slot format indicators (SFIs), wherein K is an integer greater than or equal to 1.

Aspect 37: The method of Aspect 36, further comprising: transmitting configuration information indicating a value of K.

Aspect 38: The method of any of Aspects 23-37, wherein the indication of the preference includes an indication of K non-preferred slot format indicators (SFIs), wherein K is an integer greater than or equal to 1.

Aspect 39: The method of Aspect 38, further comprising: transmitting configuration information indicating a value of K.

Aspect 40: The method of any of Aspects 23-39, wherein the indication of the preference includes an indication of one or more preferred slot format indicators (SFIs) and an indication of one or more non-preferred SFIs.

Aspect 41: The method of any of Aspects 23-40, further comprising: receiving an indication to switch traffic associated with the UE to a companion or neighbor UE associated with the UE.

Aspect 42: The method of Aspect 41, wherein the indication to switch the traffic associated with the UE to the companion or neighbor UE is included in a same communication with the indication of the preference.

Aspect 43: The method of any of Aspects 41-42, wherein the indication to switch the traffic associated with the UE to the companion or neighbor UE is based at least in part on at least one of a blockage condition at the UE or a maximum permissible exposure (MPE) condition at the UE.

Aspect 44: The method of any of Aspects 41-43, further comprising: communicating, with the companion or neighbor UE, the traffic associated with the UE in connection with receiving the indication to switch the traffic associated with the UE to the companion or neighbor UE.

Aspect 45: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-44.

Aspect 46: An apparatus for wireless communication at a device, the apparatus comprising one or more memories and one or more processors coupled to the one or more memories, the one or more processors configured to cause the device to perform the method of one or more of Aspects 1-44.

Aspect 47: An apparatus for wireless communication, the apparatus comprising at least one means for performing the method of one or more of Aspects 1-44.

Aspect 48: A non-transitory computer-readable medium storing code for wireless communication, the code comprising instructions executable by one or more processors to perform the method of one or more of Aspects 1-44.

Aspect 49: A non-transitory computer-readable medium storing a set of instructions for wireless communication, the set of instructions comprising one or more instructions that, when executed by one or more processors of a device, cause the device to perform the method of one or more of Aspects 1-44.

Aspect 50: A device for wireless communication, the device comprising a processing system that includes one or more processors and one or more memories coupled with the one or more processors, the processing system configured to cause the device to perform the method of one or more of Aspects 1-44.

Aspect 51: An apparatus for wireless communication at a device, the apparatus comprising one or more memories and one or more processors coupled to the one or more memories, the one or more processors individually or collectively configured to cause the device to perform the method of one or more of Aspects 1-44.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

WHAT IS CLAIMED IS:

1. A user equipment (UE) for wireless communication, comprising:
one or more memories; and
one or more processors, coupled to the one or more memories, configured to cause the UE to:
detect one or more trigger conditions at the UE; and
transmit, to a network node, an indication of a preference associated with downlink beam training or uplink beam training, wherein the preference is based at least in part on the one or more trigger conditions at the UE.

2. The UE of claim 1, wherein the one or more processors are further configured to cause the UE to:
receive configuration information associated with reporting the preference, wherein the configuration information indicates one or more uplink resources for transmitting the indication of the preference.

3. The UE of claim 1, wherein the indication of the preference indicates a preference for:
downlink beam training,
uplink beam training,
both downlink beam training and uplink beam training, or
neither downlink beam training nor uplink beam training.

4. The UE of claim 3, wherein the indication of the preference is a two-bit indication.

5. The UE of claim 1, wherein the preference is applicable for a configured time period.

6. The UE of claim 5, wherein the one or more processors are further configured to cause the UE to:
receive configuration information indicating the configured time period.

7. The UE of claim 6, wherein the configuration information configures periodic reporting of the indication of the preference in accordance with the configured time period.

8. The UE of claim 1, wherein the one or more trigger conditions include:
an amount of power available at the UE,
a temperature level or measured thermal overhead at the UE,
an equivalent isotropic radiated power (EIRP) at the network node associated with downlink transmission,
an EIRP at the UE associated with uplink transmission,
a link budget,
a maximum permissible exposure (MPE) condition at the UE,
a blockage condition at the UE,
a quantity of antenna modules or antenna panels available at the UE, or
any combination thereof.

9. The UE of claim 1, wherein the one or more processors are further configured to cause the UE to:
receive, based at least in part on the indication of the preference, a communication indicating downlink reference signals to be measured for downlink beam training or uplink reference signals to be transmitted for uplink beam training.

10. The UE of claim 9, wherein the downlink reference signals are channel state information reference signals (CSI-RSs), and wherein the uplink reference signals are sounding reference signals (SRSs).

11. The UE of claim 1, wherein the indication of the preference includes an indication of a preferred slot format indicator (SFI).

12. The UE of claim 11, wherein a relative quantity of downlink symbols to uplink symbols in a slot format associated with the preferred SFI is indicative of the preference associated with downlink beam training or uplink beam training.

13. The UE of claim 1, wherein the indication of the preference includes an indication of K preferred slot format indicators (SFIs), wherein K is an integer greater than or equal to 1.

14. The UE of claim 1, wherein the indication of the preference includes an indication of K non-preferred slot format indicators (SFIs), wherein K is an integer greater than or equal to 1.

15. The UE of claim 1, wherein the indication of the preference includes an indication of one or more preferred slot format indicators (SFIs) and an indication of one or more non-preferred SFIs.

16. The UE of claim 1, wherein the one or more processors are further configured to cause the UE to:
transmit, to the network node and based at least in part on the one or more trigger conditions, an indication to switch traffic associated with the UE to a companion or neighbor UE associated with the UE.

17. The UE of claim 16, wherein the indication to switch the traffic associated with the UE to the companion or neighbor UE is included in a same communication with the indication of the preference.

18. The UE of claim 16, wherein the one or more trigger conditions includes at least one of a blockage condition at the UE or a maximum permissible exposure (MPE) condition at the UE, and wherein the indication to switch the traffic associated with the UE to the companion or neighbor UE is based at least in part on the at least one of the blockage condition at the UE or the MPE condition at the UE.

19. A network node for wireless communication, comprising:
one or more memories; and
one or more processors, coupled to the one or more memories, configured to cause the network node to:
receive, from a user equipment (UE), an indication of a preference associated with downlink beam training or uplink beam training; and
transmit, to the UE and based at least in part on the indication of the preference, a communication indicating downlink reference signals to be measured for downlink beam training or uplink reference signals to be transmitted for uplink beam training.

20. A method of wireless communication performed by a user equipment (UE), comprising:
detecting one or more trigger conditions at the UE; and
transmitting, to a network node, an indication of a preference associated with downlink beam training or uplink beam training, wherein the preference is based at least in part on the one or more trigger conditions at the UE.
